(19) United States
(12) Patent Application Publication
(10) Pub. No.: US 2004/0069948 A1
(43) Pub. Date: Apr. 15, 2004

(54) Device and method for analysing the qualitative and/or quantitative composition of liquids

(76) Inventors: Arno Feisst, Gundelfingen (DE); Armin Lambrecht, March (DE); Ralf Wehrspohn, Halle (DE); Frank Muller, Reutlingen (DE); Jorg Schilling, Halle (DE)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/451,047

(22) PCT Filed: Dec. 18, 2000
(86) PCT No.: PCT/EP01/14802

(30) Foreign Application Priority Data
Dec. 18, 2000 (DE) 10063151.7

(51) Int. Cl. G01N 21/61

(52) U.S. Cl. 250/343

(57) ABSTRACT

The invention relates to a method for the analysis of the qualitative and/or quantitative composition of fluids with at least one light source, one interaction space area in which the light interacts with the fluid, and one detection device for detecting the interaction between the fluid and the light. The device and the method are characterised in that a photonic the gap structure is provided creating a greater reduced group velocity in the interaction space area and thus an increased dwell time for the light in the interaction space area. This means that the interaction space area can be considerably reduced in size, which allows a compact design of the device.

The invention relates to a device for the analysis of the qualitative and/or quantitative composition of fluids with at least one light source, at least one interaction space area in which an interaction between the light and fluid is possible, and at least one detection device for detecting the interaction between the fluid and the light.

Methods and devices are known in which the specific absorption of electromagnetic radiation by the various components of the fluids is used to analyse the composition of fluids. Many gases such as, for example, CO, CO2 or CH4 show characteristic absorption lines, especially in the infrared range. Very sensitive detection of even trace gases is also possible with the absorption method. However, it is a disadvantage that, in order to achieve a high degree of sensitivity, extended interaction ranges must be provided in which the absorption of the electromagnetic radiation by the fluid can take place. Only by allowing a long time for the interaction of the light with the fluid can a sufficient signal-to-noise ratio be produced with which a qualitative and/or quantitative analysis of the composition of fluids is possible. The large space ranges conflict with many applications where miniaturisation of the sensors is necessary. Particular reference is made here to the automobile manufacturing industry.

Other sensor principles such as electrochemical cells or semi-conductor gas sensors have the disadvantage that particular cross-sensitivities to other gas components and also, for example, to air humidity occur. Gas sensors of this type cannot guarantee the high level of precision and selectivity of optical absorption methods.

The optical absorption methods can be divided into non-dispersive, dispersive and laser-spectroscopic measurement methods. With the non-dispersive devices and methods, the absorption of an individual wavelength is detected. Often a reference wavelength is also used here with which no characteristic absorption arises. Such devices in particular show the aforementioned disadvantages as regards the large interaction space range. Dispersive devices and methods in which a spectral dependence of the fluid absorption is measured are characterised by expensive optical components such as a prism or a grating. Similarly, there is also a need here to detect different wavelengths with several detectors, which is a major disadvantage from the point of view of costs.

In many cases multi-reflection set-ups are used to achieve an extension of the time for the interaction of the light with the fluid. However, these optical systems are expensive and require precise adjustment.

With the laser-spectroscopic methods and devices, a laser is quickly coordinated via a fluid absorption line and a particular constituent of the fluid is thus determined qualitatively or quantitatively. However, the components that allow such methods, particularly the special laser diodes for this, are comparatively expensive.

Once again, the time for the interaction of the light with the fluid is decisive for detection sensitivity.

The object of the present invention is thus to provide a device and a method for the analysis of the qualitative and/or quantitative composition of fluids that can be realised cheaply and has only a low space requirement.

This object is fulfilled by a device with the characteristics of claim 1 and by a method with the features of claim 62.

In the device according to the invention, the specific optical absorption of fluid components to be analysed is utilised. The length of the interaction of the light with the fluid is increased with the help of a photonic band gap structure.

In this way it is possible to use the selectivity and sensitivity of an optical absorption method, but at the same time to guarantee a long period of interaction of the light with the fluid with a very low space requirement.

A photonic band gap structure is characterised by periodic variation of the optical refractive index at least in one spatial direction. As is the case for electron waves in a solid body, i.e. in a periodic potential, the propagation of light in a medium with a periodic refractive index produces a band structure which may also show a band gap. The dispersion relation (ω(k)) is clearly different from that of electromagnetic radiation in a vacuum or in a propagation medium.

Close to the band gap in particular, band bends occur, i.e. for particular wavelengths and. frequency ranges, very flat areas appear in the band structure particularly near the band gap. The increase in the dispersion relation Δω/Δk gives the group velocity v_{gr}. For this reason, particularly in the areas near to the band gap, because of the refractive index periodicity of the photonic band gap structure near the band gap, the group velocity is clearly reduced in comparison with the vacuum. The reduction in the group velocity because of the periodicity of the refractive index of the photonic band gap structure generally clearly exceeds the reduction in the group velocity solely as a result of the presence of a material with a refractive index other than 1.

The group velocity indicates at what speed the centre of gravity of a wave package spreads in a medium. This shows clearly that for those wavelengths and frequencies which have a flat band structure, the propagation in the photonic band gap structure is slow, so that it is possible for the light to interact with a fluid in a small space range over a comparatively long period of time.

Since photonic band gap structures contain areas with a group velocity of zero and these continuously shift into a “linear” dispersion relation with finite increase, a reduction in the group velocity in comparison with a vacuum is possible by any factor.

For physical reasons, the periods of the structures used must lie in the range of the interesting wavelengths, i.e., for average infrared periodicities, for example, in the range of 0.5 μm to 15 μm.

An advantageous embodiment of the invention is that the light source is polychromatic. Because the light is provided by the light source with various wavelengths, it is possible to determine the absorption of the fluid in various wavelength ranges and thus to determine the composition of the fluid in relation to various components at the same time.

Another advantageous embodiment of the invention is that the light source is monochromatic. If the wavelength of the light is selected according to an absorption line of a component of the fluid to be analysed, it is possible, with reasonably priced optical components, to optimise the highly sensitive sensor for a particular fluid component..

An advantageous embodiment of the invention is that the light source comprises a filament lamp, a light-emitting diode, a laser, a laser diode, quantum cascade lasers (QCL), a luminescent light source, a selective thermal emitter or a black emitter. A filament lamp, a light-emitting diode, a luminescent light source, a selective thermal emitter or a black emitter are characterised by their reasonable price. A filament lamp, a luminescent light source, a selective thermal emitter or a black emitter are characterised by a partially continuous emission spectrum which is an advantage. A laser or a laser diode are advantageously characterised by their extremely narrow-band, sharp emission spectrum. The laser diode is advantageously characterised by its generally much lower price compared with other lasers. The filament lamp, the light-emitting diode, the laser, the laser diode, the luminescent light source, the selective thermal emitter or the black emitter generally advantageously have an emission spectrum which is in the infrared range. In particular the range of the infrared spectrum is of particular interest for the absorption of fluids. The device therefore advantageously includes an infrared light source.

The light source is advantageously integrated spatially into the photonic band gap structure. Especially for light which propagates with a clearly reduced group velocity due to the periodic refractive index variation in the photonic band gap structure, the increased effective refractive index means that there is a very high level of reflectivity when the light enters into the photonic band gap structure. It is therefore advantageous to integrate the light source spatially into the photonic band gap structure, since this means that an efficient coupling of the light into the photonic band gap structure is possible. For example, it is possible to provide a thermally emitting material in an opening of a pore or other type of cavity in the photonic band gap structure.

An embodiment is advantageous in which the light source is integrated into the photonic band gap structure and is surrounded by an optical cavity. The optical cavity influences the spontaneous emission spectrum of the light source in such a way that a narrow, sharp-banded emission spectrum is created. Through the dimensions and shape of the cavity it is possible to filter out, from the otherwise continuous emission spectrum of a material, certain areas in which, on the basis of the cavity, an increased spontaneous emission rate exists (selective thermal emitter).

An advantageous embodiment of the invention is to realise the light source in the form of a layer and to affix it to the photonic band gap structure. The direct contact of the light-emitting material with the photonic band gap structure guarantees a good incorporation of the light into the photonic band gap structure.

A further advantageous embodiment of the invention is to provide, between the light source and the photonic band gap structure, a free radiation space for the propagation of the light. Because the light source is thus detached from the photonic band gap structure, it is possible to optimise, exchange, repair and further develop both components separately from each other.

A further advantageous embodiment of the invention is that an optical waveguide is provided in the form of a fibre with the help of which it is possible to transmit the light on the way from the light source to the photonic band gap structure. Optical waveguides in the form of fibres allow a flexible transmission of the light and thus a spatial detachment of the light source from the photonic band gap structure. In addition, optical waveguides have the advantage that, when they emerge, they are a strongly focused light source which is very stable in its spatial position and radiation direction in terms of time. In addition, preconfigured modules comprising a light source with a fibre already attached for the optical waveguide are available commercially at reasonable prices.

A further advantageous embodiment of the invention is to provide an integrated optical waveguide to guide the light from the light source to the photonic band gap structure. When a photonic band gap structure or a light source is produced by means of semiconductor-specific process stages, it is an advantage to produce an optical waveguide that guides the light from the light source to the photonic band gap structure at the same time. This means that optimum positioning of the light source, the waveguide and the photonic band gap structure is possible thus enabling optimum utilisation of the light provided by the light source through an efficient wave guide and linking to and separation from the waveguide.

An advantageous embodiment of the invention is that the refractive index periodicity of the photonic band gap structure is provided in one, two or three spatial directions. A refractive index periodicity in one spatial direction exists, for example in the fact that layer-shaped areas with different refractive indices periodically alternate. Here, the light can propagate perpendicular to the plane of the layer-shaped areas with a reduced group velocity due to the refractive index periodicity. A two-dimensional refractive index periodicity exists, for example, if pillar or bar type areas are provided which have a different refractive index in comparison with the surrounding medium. An advantageous embodiment of this, for example, is to produce, using strongly directed etching, pores with, for example, a circular cross-section in silicon. Because of the two-dimensional refractive index periodicity of the photonic band gap structure, it is possible to radiate the light from different directions onto the band gap structure so that the light within the band gap structure propagates in different directions. However, as long as there is one propagation component perpendicular to the direction of the pores, there will always be a reduced group velocity due to the refractive index periodicity. A three-dimensional refractive index periodicity exists when a space area with a refractive index different from the surrounding material occurs with periodic regularity in three spatial dimensions. Through this type of photonic band gap structure, light can, due to the refractive index periodicity, propagate in any spatial direction within the photonic band gap structure with a low group velocity.

A particularly advantageous embodiment of the invention exists in that the geometry of the photonic band gap structure is created in such a way that the band gap of the photonic band gap structure is essentially straight above or below a specific frequency of the light emitted by the light source. If the light source emits light that has a frequency that is straight above or below the band gap of the photonic band gap structure, there will be, specifically in these frequency ranges, a band structure with a flat band line and correspondingly a low group velocity. This is particularly advantageous for a long time of interaction between the light and the fluid.

An advantageous embodiment of the invention is that the areas in the photonic band gap structure which show a reduced or an increased refractive index are realised through pores in the material. Pores of this type can be produced quickly, precisely and cheaply, for example, using an etching method in a material, especially a semiconductor material.

A particularly advantageous embodiment of the invention is that the pores show the areas with a refractive index that is lower in comparison with the surrounding material and the geometry of the photonic band gap structure is of such a nature that the band gap is straight under the frequency of a specific light frequency which is emitted by the light source. The geometry of the photonic band gap structure is determined from the periodicity length of the refractive index periodicity and from the spread and distribution of the various refractive indices within a periodicity length of the refractive index periodicity. If the pores form the area with the reduced refractive index and if the light which is used for analysis of the fluid has a frequency directly above the band gap of the photonic band gap structure, this gives a particularly high light intensity of the light in the areas of the pores in particular. The light intensity in areas with an increased refractive index is in this case comparatively low. Because the light intensity is particularly high in the areas of the pores that cover the low refractive index, an interaction with a fluid located in the pores is particularly powerful. This means that an extremely space-saving embodiment of the invention can be carried out.

An advantageous embodiment of the invention is that the areas with the increased and reduced refractive index take the form of layers. An embodiment of this type represents a simple embodiment of the refractive index periodicity which can be produced advantageously cheaply.

An advantageous further development of the invention is that the layers show a periodic variation of their layer thickness along a specific direction. This means that it is possible to achieve a two-dimensional periodic refractive index periodicity. A possible realisation of this embodiment is to etch layer-type pores in silicon and to use a time-modulated etching rate during the etching method. This creates layers which show a period variation of their layer thickness along a specific direction in the layer plane.

An advantageous embodiment of the invention is that the areas with the reduced or increased refractive index take the form of pillars. The pillars have, advantageously, a circular, triangular, square, quadratic, rectangular, lozenge-shaped, polygonal irregularly shaped or hexagonal cross-section. Through the forming of the areas with a reduced or increased refractive index into pillars, a two-dimensional refractive index periodicity is achieved. Structures of this type can easily be produced with etching methods from semiconductor technology.

The front ends of the pillars form an overall periodic pattern so that the periodic layout of the pillars results in the necessary refractive index variation. The overall pattern is advantageously provided with a hexagonal, rhomboid, lozenge-shaped, quadratic or rectangular unit cell. By selecting the unit cell of the periodic overall pattern of the front surfaces of the pillars, an isotropy or anisotropy of the propagation of the light in the plane of the front surfaces, i.e. perpendicular to the pillar-shaped areas, can be achieved. This means that it is possible to modify the optical properties of the photonic band gap structure specifically to the specific requirements for a device for the analysis of fluids. Through various propagation characteristics in various spatial directions within the photonic band gap structure, a light guide, for example, within the periodic band gap structure or a splitting of the light in accordance with chromatic proportions is possible.

If the pillars show, along their longest extension, a periodicity of the cross-sectional area towards the longest direction of propagation, this creates a further advantageous embodiment of the invention. The periodicity of the cross-sectional area produces a three-dimensional realisation of a periodicity of the refractive index. If, for example, the areas with an increased or reduced refractive index in comparison with the rest of the material are open areas into which the fluid can enter, it is possible for the fluid to penetrate the photonic band gap structure parallel with the direction of propagation of the light in the photonic band gap structure. Scatter losses which occur upon penetration of borders of the areas with the lower and higher refractive index can thus largely be avoided.

A particularly advantageous embodiment of the invention is that at least a part of the areas showing an increased or reduced refractive index include open free spaces at least a part of which contains the fluid to be analysed. Because the photonic band gap structure provides open free spaces for the fluid to be analysed, a particularly good interaction of the light, which has been slowed down because of the refractive index periodicity of the photonic band gap structure, with the fluid is possible. This has an advantageous effect on a possible reduction of the spatial extension range of the photonic band gap structure.

A further advantageous embodiment of the invention is that the free spaces are open at least on one side of the photonic band gap structure. It is possible to replace or continuously renew the fluid in the free spaces through this opening.

A further advantageous embodiment of the invention is that the free spaces are open at least on two sides of the photonic band gap structure. This opening on two sides of the free spaces allows the fluid to be analysed to flow through the free spaces. This means that short-term changes in the composition of the fluid can be quickly detected.

A particularly advantageous embodiment of the invention is that the photonic band gap structure shows a graduated refractive index profile at least on one side of the photonic band gap structure. Because of the reduced group velocity, especially in the area for frequencies near the band gap, the photonic band gap structure for light with frequencies near the band gap shows a particularly high effective refractive index. This leads to a greatly increased reflectivity of the material for light with a specific wavelength. It is thus a problem coupling the light into the photonic band gap structure. A graduated refractive index profile on one side of the photonic band gap structure effectively corresponds to a dereflection of this side. A graduated refractive index profile produces a continuous rise in the effective refractive index and thus considerably improves the coupling in of the light into the photonic band gap structure. The graduated refractive index profile can be realised by the change in the periodicity length and by the variation of the geometric dimensions of the areas with an increased and a reduced refractive index within a periodicity length.

An advantageous embodiment of the invention is that the photonic band gap structure includes a reference area containing a reference fluid, the characteristics and composition of which can be used as a reference for the measurement of the fluid to be analysed. Because a reference area is provided with a reference fluid, a clear increase in the level of analytical precision of the device can be achieved. The reference fluid is hermetically sealed, advantageously, in the reference area. The device reference, which is thus set once, requires no further maintenance or replacement, but is rather permanently guaranteed before the device is produced.

Advantageously, the photonic band gap structure has the form of a prism. The high effective refractive index of the photonic band gap structure produces an extremely strong chromatic splitting of the light because the photonic band gap structure takes the form of a prism. Because of the chromatic splitting of the light, it is possible to examine a broad range of the spectrum as regards the absorption of the light by the fluid. This permits the detection of several fluid components at the same time.

Furthermore, it is possible, because of the geometry of the periodicity of the photonic band gap structure, to create a refractive index profile such that, through the refractive index, a prism is effectively created even if the outer form of the photonic band gap structure does not take the form of a prism. This is due to the fact, for example, that the effective refractive index in a spatial area of the photonic band gap structure has a higher value than in another spatial area of the photonic band gap structure and that the area that has a higher refractive, index takes the form of a prism.

A particularly advantageous embodiment of the invention is that within the device for example within the photonic band gap structure a catalyst is provided that has a catalytic effect at least on one component of the fluid to be analysed. The catalyst should be provided in such a way that the fluid is in contact with the catalyst. By means of the catalyst, it is possible to catalyse or to make possible at all a chemical reaction in a constituent of the fluid. In this way, it is possible to create products within the photonic band gap structure that can be detected particularly well using absorption spectroscopy. Furthermore, it is possible to measure the fluid spectroscopically before or after the catalyst and thus to follow the sequence of the reaction. It is also possible to use one of the two measurements as a reference for the other measurement. A comparative measurement of the composition of the fluid before and after the catalytic reaction increases the precision with which particular fluid components can be detected.

Advantageously, the catalyst is provided wholly or at least partly on the inside of the free spaces containing the fluid to be analysed. This guarantees particularly good contact between the fluid and the catalyst. Furthermore, it is an advantage to provide a heating device with which the catalyst can be selectively heated. This increases the reaction speed.

Advantageously, the photonic band gap structure essentially includes a material that is essentially transparent at least for a wavelength of the light that is emitted by the light source.

Transparency of the material which essentially includes the photonic band gap structure or from which the photonic band gap structure is made is important in that the reduced speed of propagation of the light creates a high absorption of the light with just a small coefficient of absorption of the material. Because of the long dwell time of the light in the photonic band gap structure, in order to reach a strong light signal, the material that is penetrated by the light must essentially be transparent for the light.

Advantageously, the photonic band gap structure essentially contains silicon which is preferably monocrystalline. Many different semiconductor process stages have been developed and optimised for silicon so that optimum integration into existing semiconductor manufacturing methods can be guaranteed. Furthermore, silicon represents a material which is available at low prices even in very high product qualities and which shows a sufficient transparency to infrared light in the infrared range of the spectrum.

A further advantageous embodiment of the invention is using a modulation device for the modulation over time of the light intensity of the light emitted by the light source. A modulation of the intensity of the light in this way allows easier detection of the light after interaction with the fluid. Using the lock-in technique or a signal filter, disturbing signals can be filtered out if the input light intensity is modulated on a time basis.

The intensity of the light can also be modulated by providing a power modulation device for the time-based modulation of the power with which the light source is supplied. The direct modulation of the power with which the light source is supplied also creates a time modulation of the emissive light intensity with the above mentioned advantages.

A further embodiment of the invention is to modulate the pressure of the fluid to be analysed using a fluid pressure modulation device. Another possibility consists in modulating the temperature of the photonic band gap structure by means of a temperature modulation device. Both the pressure and the temperature modulation lead to a modulation of the spread of the photonic band gap structure. This means, because of the changed dispersion relation, a change in the length and/or duration of the interaction of the light with the fluid, which results in a modulation of the output intensity.

An advantageous embodiment of the invention is to then detect the light which has entered an interaction with the fluid using a detector for light. This most simple embodiment in terms of the detection of the interaction between the light and the fluid is based on simply measuring the light intensity which remains after the light has interacted with the fluid. From the measurement of the intensity, a conclusion can be drawn as to the absorption of the fluid in a particular spectral wavelength range, from which the composition of the fluid can be derived.

It is an advantage that the detector is a discrete detector.

A discrete detector is an individual element which is capable of functioning as a detector in itself. A discrete detector of this type, for example, is not made in an integrated method together with other components of the device.

A further advantageous embodiment of the invention is the provision of a multiple light detector for detection of the light at several points in the device. This is particularly helpful in combination with a photonic band gap structure which guarantees a chromatic splitting of the light. With the help of a multiple light detector, it is possible to detect the light from various different wavelength ranges spatially separated and parallel in time. This means that it is possible to determine, at the same time, different components of a fluid whose composition is to be analysed.

Because infrared light is preferably used in the device, an advantageous embodiment of the invention is to provide a thermoelectric element as the detector. A thermoelectric element converts a heat signal into an electrical signal which can easily be forwarded for further processing. Advantageously, the thermoelectric element is provided in the form of layers, e.g. on the photonic band gap structure itself and includes, as an advantage, antimony and/or bismuth.

A particularly advantageous embodiment of the invention is to provide a modulation device in such a way that the intensity of the light that falls on the photonic band gap structure and that is emitted from the light source is modulated with a frequency which corresponds essentially to the acoustic frequency of a resonator mode of the photonic band gap structure. Spaces or pores in the photonic band gap structure produce acoustic resonators. The interaction of the light, especially the infrared light, with the fluid produces a time modulated pressure in the photonic band gap structure (photoacoustic effect). If the pressure is modulated with a frequency which essentially corresponds to an acoustic resonator mode of the photonic band gap structure, a resonant amplification of the pressure modulation occurs. This acoustic resonance is easy to detect.

Advantageously, the acoustic resonance is detected with a microphone for the detection of acoustic oscillations in the photonic band gap structure. The microphone advantageously includes a piezoelectric element which can be affixed, for example, directly on the photonic band gap structure.

A microphone that includes a piezoelectric element can be produced compactly and cheaply and provides an electrical output signal that can be directly further processed.

A further embodiment for the detection of the acoustic resonance consists of affixing a marking, e.g. a mirror, on the photonic band gap structure and of detecting this marking optically. This can be done for example with a further light source and a further light detector.

An advantageous embodiment of the invention is to provide a filter device to filter the output signal from the signal emitted by the detector. This filtering is carried out advantageously in such a way that essentially signal components pass through the filter with the frequency that corresponds to the frequency of the modulation of the light intensity of the fluid pressure of the fluid to be analysed or the temperature of the photonic band gap structure. In particular, these signal components are of particular interest for the quantitative evaluation of the absorption and should be let through by the filter device.

An advantageous embodiment of the invention is that the light source or a light guide is provided in such a way that the light is essentially provided for propagation at an angle to the pore axis of the photonic band gap structure.

A further embodiment of the invention is that the light is provided essentially for propagation parallel to the pore axis in the photonic band gap structure. An embodiment of this type means that it is possible to avoid scatter losses at border areas occurring when the light enters or leaves the photonic structure. The avoidance of scatter light is advantageous because it avoids a significant reduction in the actual measurement signal and furthermore because it advantageously avoids the creation of scatter light which covers the actual signal light.

A particularly advantageous embodiment of the invention is to provide a hose-type guide device to feed the fluid to be analysed in the direction of the photonic band gap structure. Using a hose-type guide device, it is possible to direct the fluid to be analysed directly and in a well bundled way to the photonic band gap structure.

A flood device to flood the photonic band gap structure with the fluid to be analysed is a further advantageous embodiment of the invention. If the photonic band gap structure is flooded with the fluid to be analysed, all the pores and free spaces in the photonic band gap structure will be penetrated or filled by the fluid to be analysed, which gives. a good measurement quality, and furthermore the constant flooding of the photonic band gap structure with the fluid to be analysed can allow a real-time measurement of the fluid composition to be carried out.

A further advantageous embodiment of the invention is to integrate the photonic band gap structure or also the entire sensor into a micromechanical flow cell. The micromechanical flow cell has devices for taking the fluid to be analysed to the photonic band gap structure and also, eventually, for controlling or regulating the fluid flow.

The method according to the invention for analysing the qualitative and/or quantitative composition of fluids, is, along with the use of a light source and a detection device for the detection of the interaction between the light emitted by the light source with the fluid, characterised in that at least a part of the light from the light source propagates at a group velocity that is reduced in comparison to a vacuum, due to the refractive index periodicity of a photonic band gap structure, and at least a part of the light that propagates at a reduced group velocity due to the refractive index periodicity of the photonic band gap structure interacts with a fluid to be analysed.

Because of the reduced propagation speed of the light in the photonic band gap structure due to the refractive index periodicity, the method according to the invention produces an increased period of interaction of the light with the fluid to be analysed. The extended interaction time creates the possibility of clearly reducing the space requirement in respect of the interaction of the light with the fluid. The method can thus be carried out advantageously in a very small spatial area.

Advantageously, the photonic band gap structure in the method according to the invention is charged with the fluid to be analysed. The charging of the band gap structure with the fluid to be analysed guarantees a good filling and a good penetration through the openings or pores or free spaces of the band gap structure by the fluid.

In an advantageous embodiment of the method according to the invention, free spaces in the photonic band gap structure are filled from one side with the fluid to be analysed. A further embodiment of the invention is that the fluid to be analysed is guided through the photonic band gap structure. This guarantees a regular renewal of the fluid in the photonic band gap structure, so that the fluid composition in the photonic band gap structure is adjusted to the fluid outside the photonic band gap structure.

A further advantageous embodiment of the method is that the light emitted from the light source, the temperature of the photonic band gap structure, the power with which the light source is supplied or the pressure of the fluid to be analysed are modulated in time. Each of these methods produces a modulation of the output signal which can thus be detected with a very good signal-to-noise ratio.

Advantageously, the method is carried out in such a way that at least one component of the fluid to be analysed participates in a chemical reaction which is catalysed within the photonic band gap structure. The combination of a catalytic reaction with the detection of a specific fluid component means that it is possible to develop sensors for very specific fluid components, the direct, uncatalysed detection of which would be difficult because of the low optical absorption.

Advantageously, the method is carried out in such a way that the catalyst is heated. This means that, advantageously, an increased reaction speed of the catalytic reaction can be achieved.

Advantageously, the method is carried out in such a way that a reference analysis of a known reference fluid is carried out, whereby the reference analysis is based on the same physical principles as the analysis of the fluid to be analysed itself. Carrying out a reference analysis means that it is possible to ensure the function of the method in itself and furthermore to achieve an increased level of precision in the analysis of the composition of the fluid due to the possibility of comparison.

Advantageously, the method is carried out in such a way that the output signal of the detector is filtered and essentially only those signal components are not filtered out that correspond to a specific modulation frequency. This modulation frequency may be given, for example, through the modulation of the intensity of the light, the temperature of the photonic band gap structure, the pressure of the fluid to be analysed or the power with which the light source is supplied. Those signal components which show a modulation in the area where the fluid interacts with the light provide a measure for the interaction of the light with the fluid, i.e. for its absorption in particular. For this reason, these signal components should advantageously not be filtered out when executing the method according to the invention.

An advantageous embodiment of the method furthermore is to dispersively split the light falling onto the photonic band gap structure and to detect the light that has been chromatically split in this way in a spectrally separated form. The chromatic splitting and the spectrally separated detection mean that it is possible to determine different components of the fluid to be analysed qualitatively and/or quantitatively at the same time.

A particular advantageous embodiment of the method according to the invention is that in the photonic band gap structure essentially only light is propagated that corresponds to an absorption line or absorption band of the fluid component that is preferably analysed qualitatively and/or quantitatively. Because the frequency or wavelength of the light that propagates in the band gap structure is selected according to an absorption band or absorption line of a fluid component to be detected, there is a particularly high absorption of the light by the fluid in the area of the photonic band gap structure. This guarantees a higher signal-to-noise ratio.

The following explains the structure of the device according to the invention and the method according to the invention using the attached figures. These show:

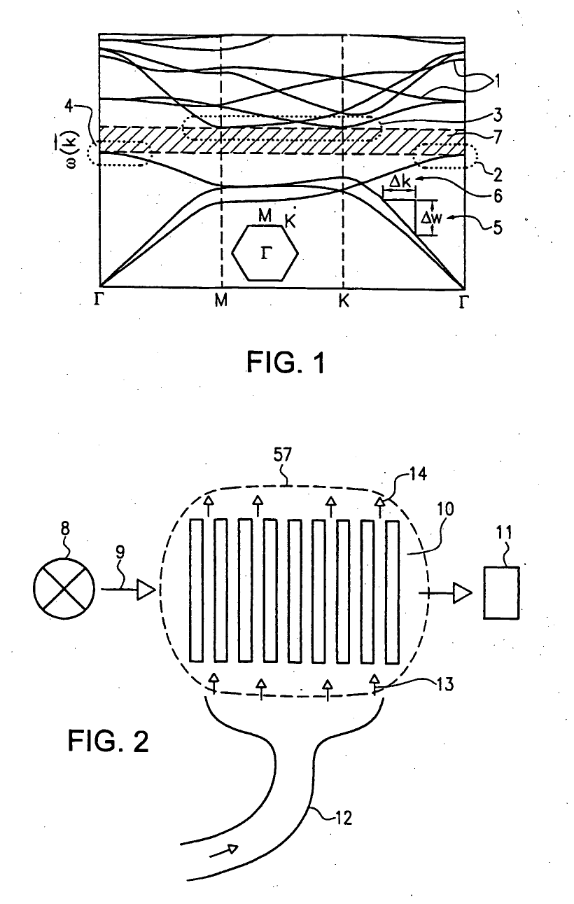

FIG. 1 An example of a photonic band gap structure (hexagonal 2d photonic crystal);

FIG. 2 A schematic diagram of an embodiment of the device according to the invention;

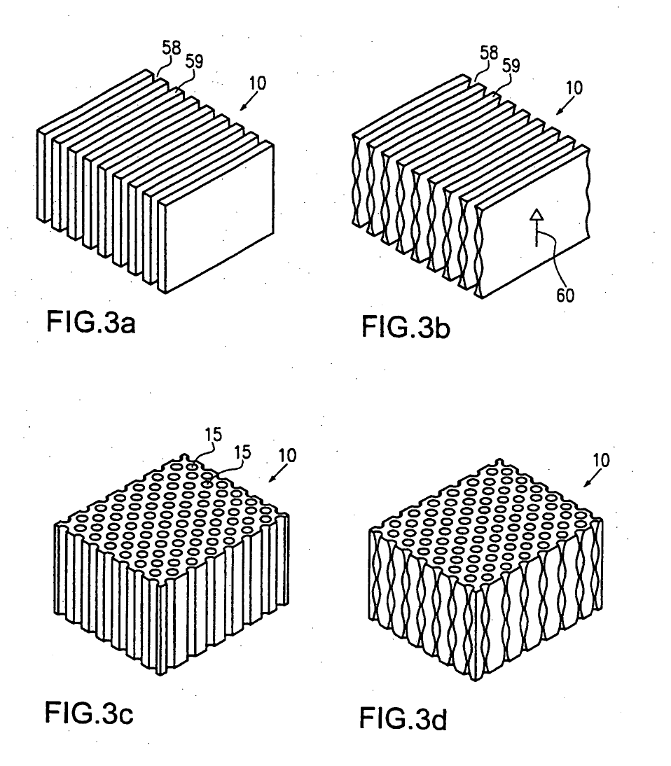

FIG. 3 Various photonic band gap structures which could be used in the device according to the invention;

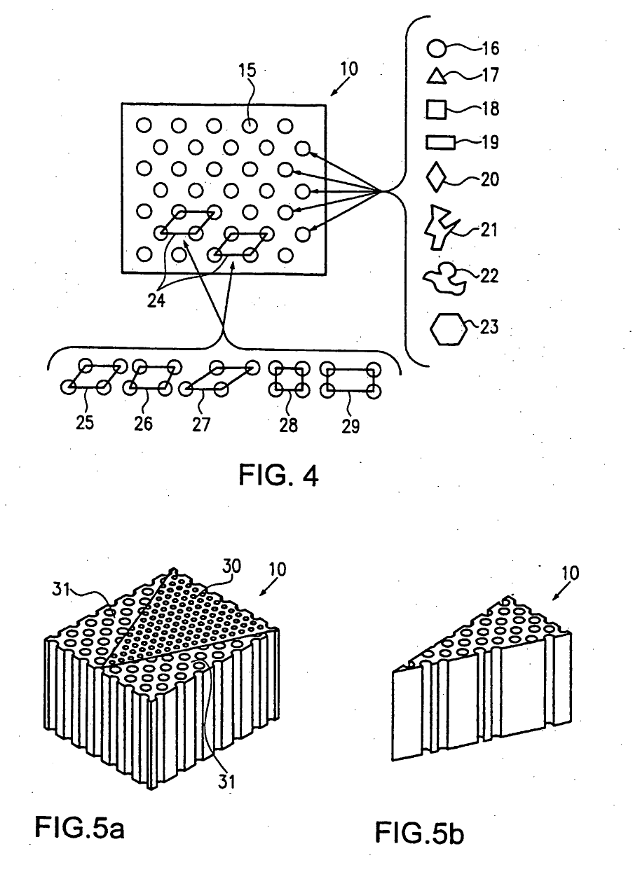

FIG. 4 The possibilities for selecting the structure of a photonic band gap structure as used in the device according to the invention;

FIG. 5 A photonic band gap structure as used in the device according to the invention in which prismatic effects occur;

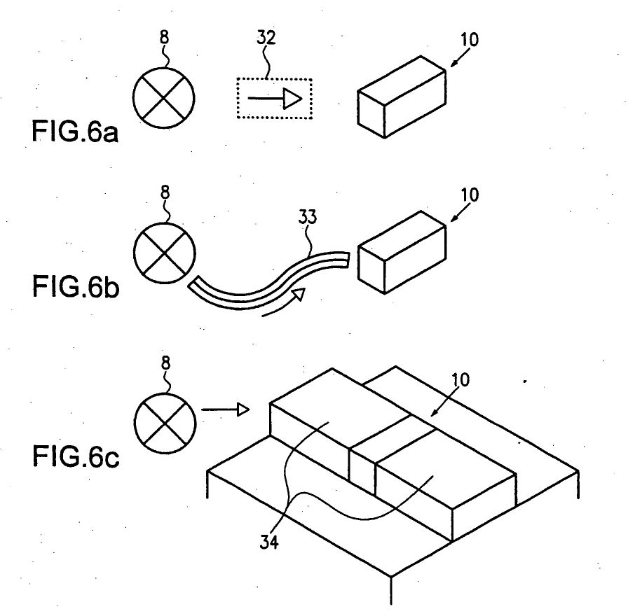

FIG. 6 Various possibilities for guiding light from the light source to the photonic band gap structure;

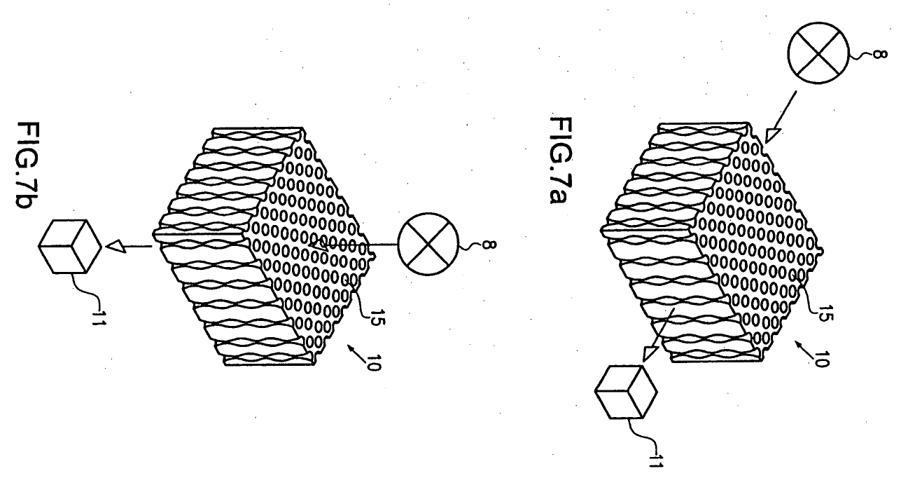

FIG. 7 Various layouts of the light source of the photonic band gap structure and the detector in relation to each other;

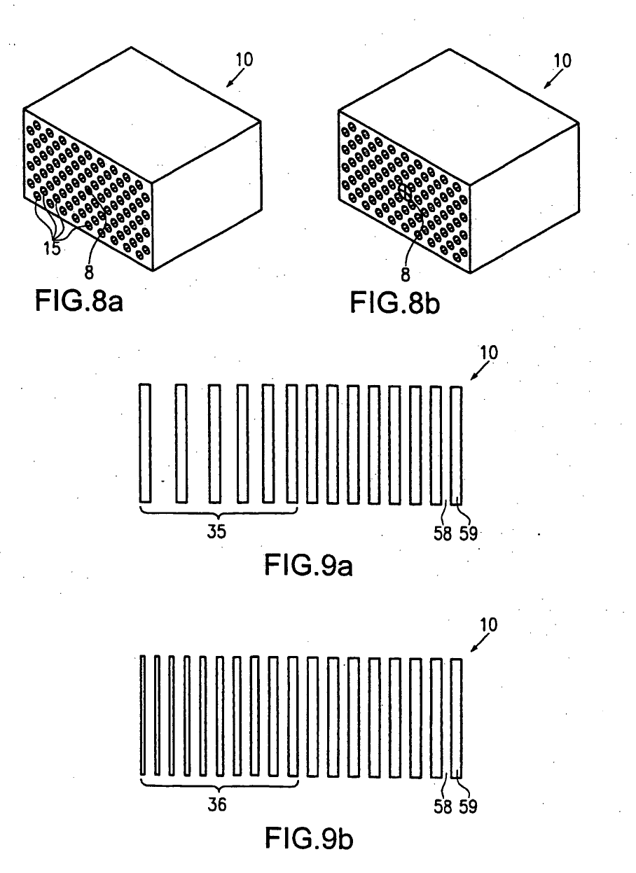

FIG. 8 A light source integrated into the photonic band gap structure;

FIG. 9 Photonic band gap structures with a graduated side;

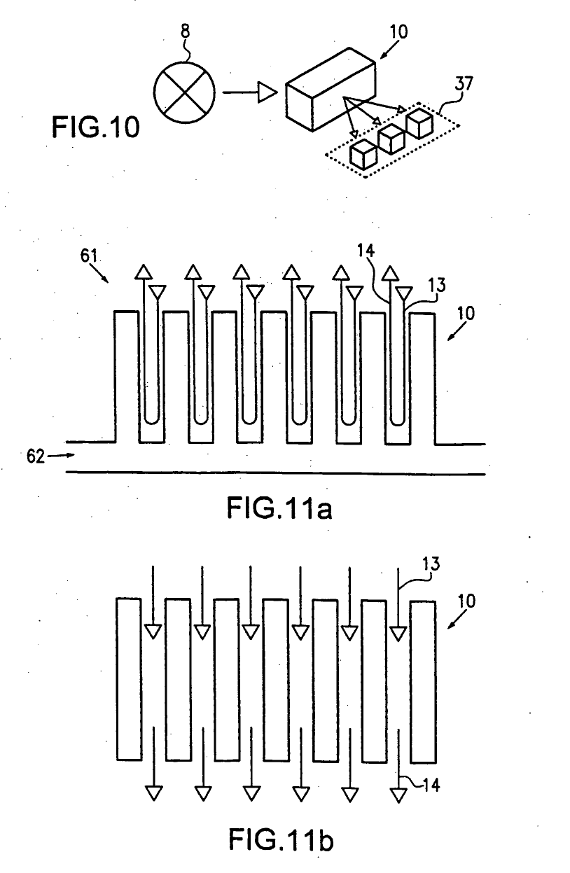

FIG. 10 An embodiment of the device according to the invention in which light is split chromatically and light is detected with different wavelengths;

FIG. 11 A photonic band gap structure opened on one side and opened on two sides as used in the device according to the invention;

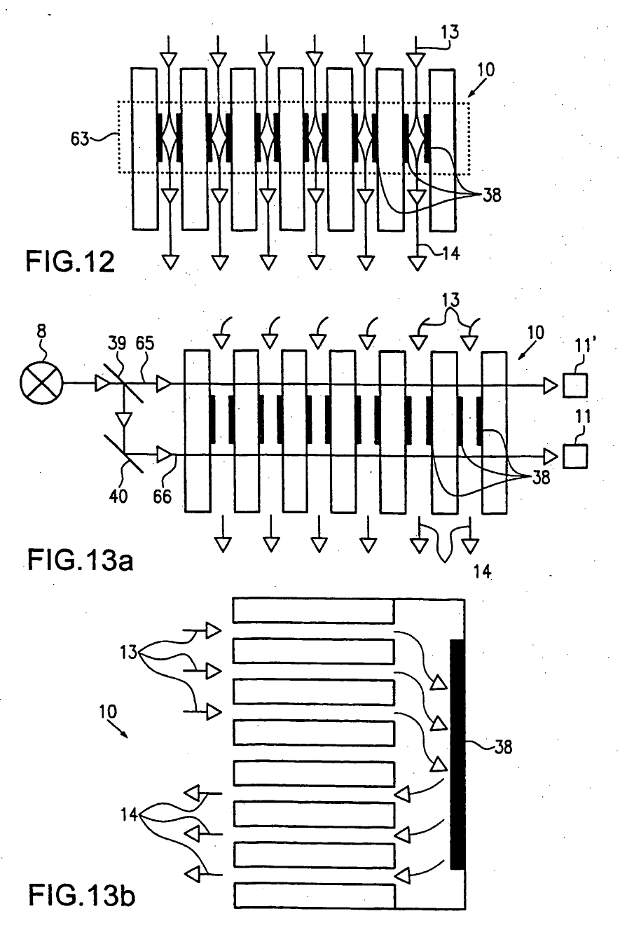

FIG. 12 A photonic band gap structure as used in the device according to the invention with a catalyst;

FIG. 13 A schematic diagram of the device according to the invention using a catalyst and a reference measurement;

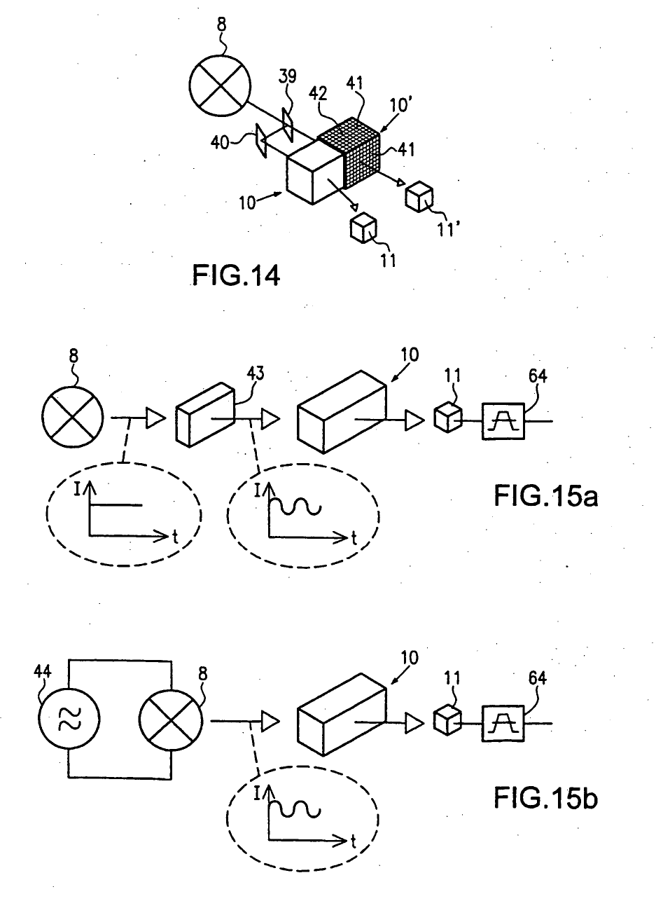

FIG. 14 A device according to the invention with the equipment to carry out a reference measurement;

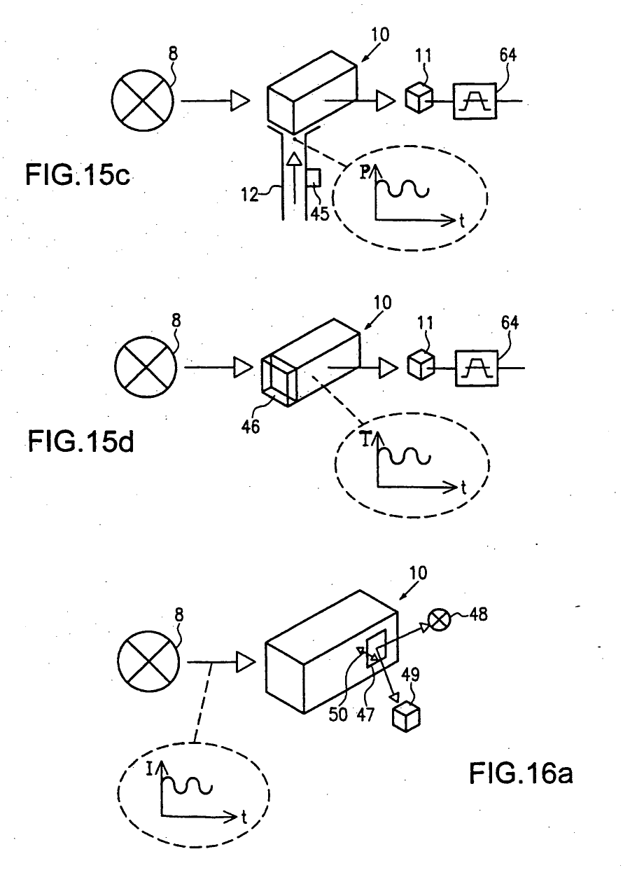

FIG. 15 Possibilities for modulating the signal;

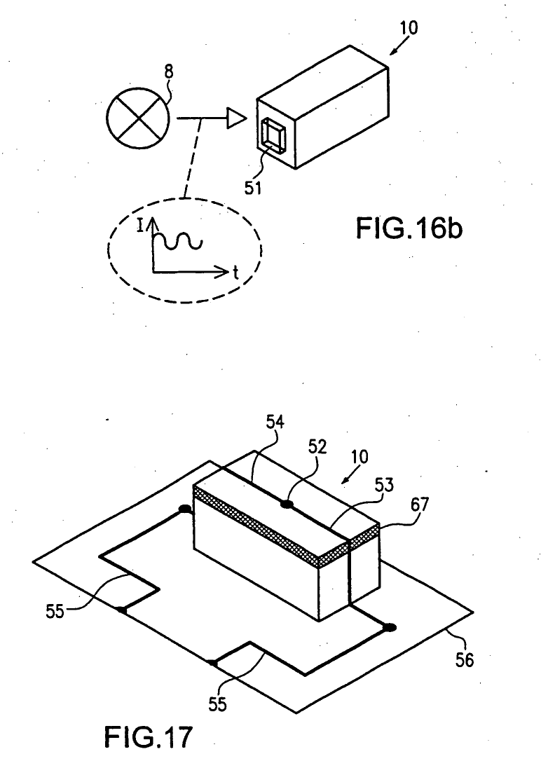

FIG. 16 Possibilities for detecting the interaction between the fluid and the light by stimulating acoustic oscillations in the photonic band gap structure;

FIG. 17 Detecting the light by means of a thermoelectric element.

FIG. 1 shows an example of a photonic band gap structure with the photonic bands 1. The areas 2, 3 and 4 designate the areas in which a flat band progress ion occurs. The group velocity is vgr, which is derived from the quotient Δω/Δk (5/6). In the areas 2, 3 and 4, the group velocity is very low. The hatched area 7 marks the photonic band gap for frequencies ω(k). For frequencies in the range of the photonic band gap, propagation of the light is not possible.

FIG. 2 shows the device according to the invention with the light source 8 which emits light in the direction 9 of the photonic band gap structure 10. Fluid 13 enters the photonic band gap structure 10 through an infeed or flood device 12. The emerging fluid 14 leaves the photonic band gap structure 10. A detector 11 measures the light intensity of the light which has entered through the photonic band gap structure 10. The reference FIG. 57 designates the interaction space area.

FIG. 3a shows a one-dimensional photonic band gap structure as used in the device according to the invention. The areas with the increased 59 and the reduced 58 refractive index take the form of layers. FIG. 3b shows a photonic band gap structure as used in the device according to the invention in which the areas with the reduced 58 and increased 59 refractive index take the form of layers but the layer thickness in a direction 60 shows a periodically changing layer thickness. This shows a two-dimensional photonic band gap structure. FIG. 3c shows a further embodiment of a two-dimensional photonic band gap structure used as an alternative in the device according to the invention. Here, the areas with increased or reduced refractive index take the form of pillars. FIG. 3d shows an example of a three-dimensional photonic band gap structure as it could be used in the device according to the invention. The pillars have a cross-sectional area which varies periodically along their axis.

In FIG. 4, the reference FIG. 15 relates to an area which, in comparison with the surrounding material, has a higher or lower refractive index. Area 15 takes the shape of a circle 16, triangle 17, square 18, rectangle 19, lozenge 20, polygon 21, an irregularly formed area 22 or a hexagon 23 as a cross-sectional area. The areas 15 are laid out according to a unit cell 24. The unit cell 24 can take the shape of a hexagonal 25, rhomboid 26, lozenge-shaped 27, quadratic 28 or rectangular 29 unit cell. Any combination of the unit cells 25 to 29 with the areas 15 with a cross-sectional area according to 16 to 23 is used in the device according to the invention.

FIG. 5 shows examples in which the photonic band gap structure fulfils the function of a prism. FIG. 5a shows two different areas 30 and 31 in which the photonic band gap structure has a different geometry. This means that there are different effective refractive indices for the light used and the form of the area 30 or the area 31 creates the function of a prism which consists of splitting the light chromatically. FIG. 5b shows another embodiment of a photonic band gap structure 10 characterised in that it has the form of a prism.

FIG. 6 shows the possibilities of how the light from a light source 8 is led to a photonic band gap structure 10 within the device according to the invention. FIG. 6a shows the possibility of taking the light from the light source 8 to the photonic band gap structure 10 by means of a free radiation space range 32. FIG. 6b shows a fibre 33 which takes the light from the light source 8 to the photonic band gap structure 10. FIG. 6c shows an integrated optical waveguide 34 which takes the light from the light source 8 to the photonic band gap structure 10. At least one of these embodiments of FIGS. 6a, 6b and 6c is used in the device according to the invention.

The chip with the waveguide and the PBG structure according to FIG. 6c could, for example, be incorporated at both ends of the waveguide with fibre plugs.

FIG. 7 shows the various possibilities of arranging the light source 8 and the detector 11 in relation to an excellent geometric direction of the photonic band gap structure 10. In FIG. 7a, the light from the light source 8 propagates in a direction perpendicular to the pore axis of the pores which in the photonic band gap structure 10 represent the areas with increased or reduced refractive index 15. In FIG. 7, the light from the light source 8 propagates in a direction parallel to the longest extension of the areas with a reduced or an increased refractive index 15 in the photonic band gap structure 10 on the way from the light source 8 to the detector 11.

A further embodiment of the device according to the invention contains a photonic band gap structure and a light source as shown in FIG. 8. In FIG. 8a, the light source 8 is integrated in one of the areas 15 which have a reduced or increased refractive index compared with the surrounding material. Because, as mentioned above, light with frequencies which correspond to an area with a flat band course in the photonic band structure penetrates the photonic band gap structure only with difficulty or with a high coefficient of reflection, it is advantageous to. produce the light directly in the photonic band gap structure. A further embodiment of the photonic band gap structure and the light source as they could be used in the device according to the invention is shown in FIG. 8b, in which an area different from the areas 15 contains the light source 8.

FIG. 9 shows the possibilities of creating a graduated refractive index profile 35, 36 on at least one side of the photonic band gap structure 10. FIG. 9a shows the possibility of changing the periodicity of the photonic band gap structure on one side in order thus to continually vary the effective refractive index. Area 35 shows the possibility of increasing the periodicity length, but it would, alternatively, also be possible to reduce the periodicity length. FIG. 9b shows the possibility of leaving the periodicity length constant in the area 36 but of varying the structure within the periodicity length. The areas with a reduced refractive index 58 become increasingly large in the area 36 from right to left and the effective refractive index in the area 36 thus changes continually. Alternatively, it would be equally possible to enlarge the areas 59 with an increased refractive index continually from right to left and thus once again to create a graduated refractive index profile in the area 36.

FIG. 10 shows the device according to the invention in which the light from a light source 8 is chromatically split in the photonic band gap structure 10. This splitting can be achieved for example by the prism (FIG. 5a). The detector group 37 detects the light with different wavelengths. It is thus possible to detect the light with different wavelengths at the same time.

FIG. 11a shows a photonic band gap structure 10 that is opened on one side 61 and closed on the other side 62. The incoming fluid 13 enters on the side 61 into the photonic band gap structure. The outgoing fluid 14 leaves the photonic band gap structure 10 on the same side 61. FIG. 11b shows a photonic band gap structure 10 that is open on two sides. The incoming fluid 13 enters the photonic band gap structure on one side. The outgoing fluid leaves the photonic band gap structure 10 on a different side of the photonic band gap structure 10. Even if FIG. 11a and FIG. 11b show a section through a photonic band gap structure 10 according to FIGS. 3a and 3c respectively, it is also possible to use photonic band gap structures of the type shown in FIG. 3b or 3d.

FIG. 12 shows a photonic band gap structure 10 with an integrated catalyst 38. The fluid 13 enters on one side into the photonic band gap structure 10 and a component of the fluid reacts with the help of the catalyst 38 according to a specific chemical reaction. The outgoing reaction products 14 leave the photonic band gap structure 10 on another side. However, it would also be possible here to use a photonic band gap structure as shown in FIG. 11a which is only open on one side 61. Here too, it should be pointed out that the sectional drawing of the photonic band gap structure 10 shows sections of FIGS. 3a and 3c in FIG. 12, but it would also be possible to use a photonic band gap structure with a catalyst according to FIGS. 3b and 3d.

The statements above relating to FIGS. 3a and 3c also apply for FIG. 13. FIG. 13 shows a device according to the invention in which the light from a light source 8 is divided into two bundles of beams by a beam divider 39. Using a mirror 40, the light is deflected in the direction of the photonic band gap structure 10. The photonic band gap structure 10 contains a catalyst 38. The incoming fluid 13 which contains the starting products of the chemical reaction that was catalysed by the catalyst 38 is measured by means of a first light beam 65. The detector 11′ registers the light penetrating through the photonic band gap structure. The fluid 14 emerging from the photonic band gap structure 10 after the completion of the chemical reaction that was catalysed by the catalyst 38 is measured by means of a second light beam 66. The detector 11 registers the light that has entered the fluid which contains the end products of the chemical reaction.

FIG. 14 shows an embodiment of the device according to the invention in which a part of the photonic band gap structure 10′ with a hermetic closure 41 contains a reference fluid 42. By means of a beam divider 39, the light from the light source 8 is divided into two bundles of beams, whereby one bundle is deflected by a mirror 40 in the direction of the photonic band gap structure. The light that penetrates the reference area 10′ of the photonic band gap structure is measured by the detector 11′ and the light that penetrates through the area 10 of the photonic band gap structure containing the fluid to be analysed is measured by the detector 11.

In the event of a three-dimensional photonic band gap structure 10 it is also possible, in deviation from the illustration in FIG. 13 and also for FIG. 14, to penetrate the photonic band gap structure 10 with both partial beams 65, 66 parallel to the axis of the pores. This is shown for one beam only in FIG. 7b.

FIG. 13b shows a further embodiment of the invention in which the photonic band gap structure 10 and the catalyst 38 are separated from each other spatially. The fluid 13 is taken in a part of the photonic band gap structure 10 to the catalyst 38 and after contact with the catalyst 38 taken away again through a different part of the photonic band gap structure and measured there. Alternatively, it would also be possible to guide the fluid 14 after contact with the catalyst 38 through a second photonic band gap structure and to carry out the second measurement there. The light from the first measurement penetrates the photonic band gap structure 10 perpendicular to the axis of the pores or plane of the layer in the area in which the liquid 13 flows in the photonic band gap structure 10 towards the catalyst 38. The use of a three-dimensional photonic band gap structure with penetration along the axis of the pores is also possible with this embodiment.

FIG. 15 shows various ways in which the measurement signal can be modulated. FIG. 15a shows a modulation device 43 which modulates the light that is emitted by the light source 8. Whilst the light intensity I is constant as a function of the time t before the modulation device 43, the light intensity I as a function of time t shows a time modulated behaviour after the modulation device 43. FIG. 15b shows a current modulation device 44 which modulates the power with which the light source 8 is supplied over time. As shown in FIG. 15b, the light intensity I as a function of the time t shows a behaviour that varies over time. FIG. 15c shows the possibility of varying the signal intensity through the pressure of the fluid in the photonic band gap structure 10. A pressure modulation device 45, which is shown here, for example, in an infeed device 12 which takes the fluid to the photonic band gap structure 10, modulates the pressure of the fluid over time. This means that the pore openings or spaces in the photonic band gap structure 10 expand or contract, which produces a modulation in the refractive index. In FIG. 15d, instead of the pressure of the fluid, the temperature T as a function of the time t is modulated over time by means of a temperature modulation device 46. This also leads to a time variable change in pore size and thus produces a time-based variability of the refractive index in the photonic band gap structure 10. The pressure modulation as shown in FIG. 15c or the temperature modulation as shown in FIG. 15d produces a modulation in the optical light signal which is registered with the detector 11.

FIG. 16 shows an alternative possibility for detection relating to the interaction between the fluid and the light from the light source. The devices shown in FIG. 16 can be used in any afore-mentioned embodiments of the device according to the invention or parts of the device according to the invention. Instead of detecting the light that has passed through the photonic band gap structure 10 in order to determine the absorption of the light in the photonic band gap structure, use is made of the property that photonic band gap structures often contain cavities which serve as acoustic resonators. If the intensity I of the light as a function of the time t is modulated on a time basis as shown in FIG. 16, a time-based modulation of the temperature and thus of the pressure of the fluid in the photonic band gap structure 10 occurs within the photonic band gap structure due to the absorption of the light in the fluid. This time-based variation of the pressure is the equivalent of an acoustic stimulation of the fluid in the photonic band gap structure 10. If the acoustic stimulation has a frequency which corresponds to the natural acoustic frequency of the photonic band gap structure, then a resonant step-up of the acoustic stimulation will occur. This means that it is particularly easy to detect an acoustic stimulation of this type.

Firstly, it is possible, as shown in FIG. 16a, to affix a marking 47 on the photonic band gap structure 10, which oscillates back and forth in, for example, the direction 50. The movement of the marking 47 is registered by means of a second light source 48 and a marking light detector 49. A further method of detecting the acoustic stimulation in the photonic band gap structure 10 is to affix a microphone 51 to the photonic band gap structure 10. Alternatively, it would also be possible to affix the microphone at a certain distance from the photonic band gap structure, although steps should be taken to ensure that the sound can reach the microphone 51 from the photonic band gap structure 10. The microphone 51 can include a piezoelectric element which transforms sound waves directly into electrical voltage. Electrical voltages can be handled particularly advantageously when evaluating the signal. In this method, no direct detection of the light that has passed through the photonic band gap structure is carried out, but because it is possible to produce acoustic stimulations in the photonic band gap. structure with infrared light and these stimulations are possibly resonantly stepped up, it is easily possible to detect these resonantly stepped up oscillations by means of a microphone 51 or a marking 47.

A special embodiment of the detection device which can be used in the device according to the invention is shown in FIG. 17. On a heat sink 56, supply leads 55 are shown which are made preferably from a good electrical conductor such as gold. Using two further materials 53, 54, such as antimony 53 and bismuth 54, a thermoelectric contact 52 is produced which is between the supply leads 53 and 54. The supply leads 53 and 54 can run here optionally, for example, via the photonic band gap structure 10. The supply leads 53, 54 are advantageously separated from the photonic band gap structure 10 by an insulating layer 57. With an embodiment according to FIG. 17, the light, for example, is passed from below into the photonic band gap structure 10 and the thermoelectric contact 52 measures the radiation which has penetrated through the photonic band gap structure. In this embodiment, the thermoelectric contact is affixed directly on the photonic band gap structure, but it would also be perfectly possible to attach the thermoelectric contact at a certain distance from the photonic band gap structure in order in this way to detect the radiation that has penetrated the photonic band gap structure. However, advantageously, because of the low thermal conductivity of the porous structure, the thermoelectric layer (with the electrical insulating layer below it) is positioned directly on the pore cross-sectional area. In addition, it is also possible to use several thermoelectric contacts instead of a single thermoelectric contact, in order to have a possibility of detecting the radiation at several points within the device according to the invention. This can be used, firstly, to obtain a better signal-to-noise ratio by means of several measurements or secondly, if the light is split chromatically, to detect light of different wavelengths at the same time.

The method according to the invention is explained using the embodiments of the device according to the invention as shown in the figures.

With the method according to the invention, the light from a light source 8 propagates in the photonic band gap structure 10 in such a way that due to the periodic refractive index variation in the photonic band gap structure the light propagates with a clearly reduced group velocity. The light which propagates with a reduced group velocity due to the refractive index periodicity can interact with the fluid 13. Here, it is possible, firstly, that the fluid is located spatially within the area of the photonic band gap structure, i.e., for example, has entered the pore spaces or other openings in the photonic band gap structure, but it is also possible that the fluid is close to the photonic band gap structure so that the evanescent light that is propagating in the photonic band gap structure with a reduced group velocity due to the refractive index periodicity interacts with the fluid. Because the light is propagating at a reduced group velocity, the dwell time of the light in a particular space area increases. If the fluid to be analysed is in the space area, there will also be an increased time for interaction between the light and the fluid. This means that the interaction volume can be greatly reduced in accordance with the increase in the dwell time. Generally, the photonic band gap structure is charged with the fluid to be analysed. This can happen for example using a hose-type guide system or using guide plates or other fluid guiding devices.

The interaction between the light and the fluid is detected with a detection device. This detection device may, for example, take the form that a light detector detects the light that has interacted with the fluid. A low light intensity corresponds here to a strong absorption of the light by the fluid which indicates a high concentration of a specific fluid component which shows an absorption for the wavelength of the light used. With the method according to the invention, the light from a light source can be brought in from the outside into the photonic band gap structure, but it is also possible for the light to be produced within the photonic band gap structure itself. If the light is to be brought in from an external light source 8 into the photonic band gap structure 10, this can be done by the light penetrating a free radiation space range 32 or being guided in by a fibre 33. Similarly, it is possible to use an integrated optical waveguide 34, which also guides the light efficiently from an external light source to the photonic band gap structure. The use of optical waveguides 33, 34 has the advantage that the light source and the photonic band gap structure can be separate from each other. This increases flexibility in the design of the device according to the invention.

A further embodiment of the method according to the invention is to provide an optical element which brings about a chromatic splitting of the light. Advantageously, this chromatic element is provided directly by the photonic band gap structure 10. As shown in FIG. 10, the light from a light source 8 is divided chromatically, by the photonic band gap structure 10, into various partial beams which are detected here by a group of detectors 37. Instead of a group of detectors 37, it is also possible to use an array of detectors. Because of the simultaneous detection of the light with different wavelengths, it is possible to determine different fluid components at the same time and also to increase the precision with which a single fluid component is determined. If a fluid component has different absorption lines, these different absorption lines can be detected by different detectors, and a greater precision of measurement sensitivity is thus achieved. If different fluid components have absorption lines for different wavelength ranges, these different wavelength ranges can be detected with different detectors and different fluid components can thus be detected.

An embodiment of the method according to the invention is to bring in the fluid 13 on a side 61 of the photonic band gap structure. The outgoing fluid leaves the photonic band gap structure on the same side 61 (FIG. 11a).

A further embodiment of the method according to the invention is to have the fluid 13 enter the photonic band gap structure 10 on one side. Here, the fluid 14 leaves the photonic band gap structure again on another side. The sides on which the fluid 13 enters the photonic band gap structure 10 and the fluid 14 leaves the photonic band gap structure. 10 again do not necessarily have to be on opposite sides of the photonic band gap structure. If the fluid enters the photonic band gap structure at an incline, the two different sides can also be, for example, arranged at an angle of 90°, or also at any other angle.

A particular embodiment of the method according to the invention is to subject the fluid to a catalytic chemical reaction. Here, a fluid component or the entire fluid can participate in the catalytic chemical reaction. As shown in FIG. 12, the fluid with the starting products of the catalytic chemical reaction is passed into the photonic band gap structure 10 and reacts with the catalyst 38 within the photonic band gap structure. The end products of the chemically catalysed reaction emerge again as fluid 14 from the photonic band gap structure.

In this, the catalyst 38 can be selectively heated using the catalyst heater 63. The selectivity of the heating can be achieved, for example, by the catalyst material absorbing electromagnetic radiation which is not absorbed by the surrounding material. If the catalyst heater 63 emits infrared light of a wavelength that is absorbed particularly well by the catalyst material 38, selective heating of the catalyst can thus be achieved.

As shown in FIG. 13, it is thus possible, for example, to detect the starting products and the end products of the chemically catalysed reaction. A light beam 65 penetrates the photonic band gap structure in an area in which the starting products of the chemically catalysed reaction are located. The concentration of the starting products is thus measured with a detector 11′. The absorption of the end products is measured with a second light beam 66, which penetrates the photonic band gap structure in an area containing the end products of the chemical reaction that was catalysed by the catalyst 38. The concentration of the end products of the chemical reaction can thus be determined with the detector 11. In this way, it is possible to follow the course of the chemical reaction. In addition, it is possible, through using a suitable catalyst for a special first fluid component, to achieve a conversion of this first fluid component into a second fluid component which can be particularly well detected by means of the infrared absorption spectroscopy used. This is a way of achieving indirect proof of a fluid component which would otherwise be difficult to detect. This is particularly of interest if a fluid component is to be detected which has no absorption bands or only poorly defined absorption bands or if the absorption bands are in a frequency range which is difficult to access due to technical problems.

A particular embodiment of the method according to the invention is to carry out a reference measurement together with the actual measurement. As shown in FIG. 14, the photonic band gap structure is penetrated in the area 10′ with a reference fluid 42 which is enclosed by a hermetic closure 41. The composition of the reference fluid 42 is known. For this reason, the measurement signal of the detector 11′ can be used as a reference measurement for measurement with the detector 11. The detector here registers the light that penetrates the photonic band gap structure 10 in an area in which the photonic band gap structure is penetrated by the fluid to be analysed. Carrying out a reference measurement increases, firstly, the precision of the measurement carried out, and secondly it is possible to monitor the function, in principle, of the device according to the invention. If the measurement signal from the detector 11′ is outside a specified range which is derived from the reference fluid 42, it must be assumed that the device according to the invention is faulty.

A further special embodiment of the method according to the invention is to modulate the signal that is detected by the detection device with reference to the interaction of the fluid with the light. This can be done, firstly, as shown in FIG. 15a by a modulation device 43 modulating the intensity of the light falling on the photonic band gap structure 10. Together with a filter device 64 which filters out frequencies which are outside the range corresponding to the modulation frequency of the light falling on the photonic band gap structure 10, the signal-to-noise ratio can be considerably improved. The filter device 64 may be for example a lock-in amplifier but it may also be a simple frequency band-pass.

A modulation of the intensity of the light falling on the photonic band gap structure can also be achieved by the power supply 44 that supplies the light source 8 with power giving off a modulated current. Due to this, a modulated intensity of light is directly emitted from the light source 8, which falls onto the photonic band gap structure 10. As shown in FIGS. 15c and 15d, it is also possible to achieve the signal through an oscillation of the mechanical structure of the photonic band gap structure 10. This can be done, firstly, through a modulation of the fluid using a pressure modulation device 45 which is shown here for example in an infeed device 12 to the photonic band gap structure. Using a temperature modulation device 46 as shown in FIG. 15d, it is also possible to vary the temperature of the photonic band gap structure over time. As with the pressure modulation shown in FIG. 15c, the temperature modulation brings about a change over time in the size of the photonic band gap structure and thus also in the optical characteristics of the photonic band gap structure. In this way, the signal leaving the photonic band gap structure and emerging in the direction of the detector 11 is modulated over time. Together with the filter 64, this thus improves the signal-to-noise ratio.

A further embodiment of the method according to the invention is to use the acoustic resonator properties of a photonic band gap structure. The pores or openings in the photonic band gap structure create very good acoustic resonators with a well defined natural frequency. If the light falling on the photonic band gap structure 10 has an intensity modulated over time, then, due to the absorption of the light in the fluid in the photonic band gap structure, the temperature/pressure of the fluid is modulated over time. If the fluctuation of the pressure over time is tuned to the natural frequency of the acoustic resonator, this produces a resonant step-up of the acoustic oscillation. This type of acoustic oscillation can easily be registered for example using a microphone 51 as shown in FIG. 16b. It is of particular advantage here to provide a microphone that includes a piezoelectric element since an element of this type converts pressure fluctuations directly into electrical signals.

A further possibility of carrying out the method according to the invention consists of affixing a marking 50, for example a mirror or an optical cross hair marking or a marking, for example with very different brightness values, on the photonic band gap structure 10. Because of the acoustic oscillation of the photonic band gap structure, the marking 47 on the photonic band gap structure 10 also oscillates. This oscillation may take place for example in the direction 50. The marking 47 can be optically detected for example using a lighting device 48 and a marking light detector 49.

1. Device for the analysis of the qualitative and/or quantitative composition of fluids (13, 14) with:
at least one light source (8),
at least one interaction space area (57) which can be penetrated both at least partly by the fluid (13, 14) and at least partly by the light from the light source (8) and in which an interaction between at least a part of the fluid (13, 14) and a part of the light from the light source (8) is possible, and
at least one detection device (11, 11′, 51, 47, 48, 49, 37) for detecting the interaction between the fluid (13, 14) and the light from the light source (8),
characterised in that
at least one photonic band gap structure (10) is provided, and for at least a part of the light from the light source (8) in the area of the interaction space area (57) due to the refractive index periodicity of the photonic band gap structure (10) at least as regards one propagation direction of the light a group velocity exists which is reduced compared to a vacuum and which is not zero.

2. Device according to claim 1, characterised in that the light source (8) is polychromatic.

3. Device according to claim 1, characterised in that the light source (8) is monochromatic.

4. Device according to one of the claims 1 to 3, characterised in that the light source (8) is a filament lamp, a light-emitting diode, a laser, a laser diode, a quantum cascade laser, a luminescent light source, a selective thermal emitter or a black emitter.

5. Device according to one of the claims 1 to 4, characterised in that the light source (8) includes an infrared light source.

6. Device according to one of the claims 1 to 5, characterised in that the light source (8) is integrated spatially into the photonic band gap structure (10).

7. Device according to one of the claims 1 to 6, characterised in that the light source (8) is integrated into the photonic band gap structure (10) and is surrounded by an optical cavity.

8. Device according to one of the claims 1 to 5, characterised in that the light source (8) is applied in the form of a layer onto the photonic band gap structure (10).

9. Device according to one of the claims 1 to 5, characterised in that the device includes a free radiation space (32) for the propagation of the light from the light source (8) in the direction of the photonic band gap structure (10).

10. Device according to one of the claims 1 to 5, characterised in that a light wave guide in the form of a fibre (33) is provided for guiding the light on the way from the light source (8) to the photonic band gap structure (10).

11. Device according to one of the claims 1 to 5, characterised in. that an integrated optical waveguide (34) is provided for guiding the light on the way from the light source (8) to the photonic band gap structure (10).

12. Device according to one of the claims 1 to 11, characterised in that a one, two or three dimensional refractive index periodicity of the photonic band gap structure (10) is provided.

13. Device according to one of the claims 1 to 12, characterised in that the geometry of the photonic band gap structure (10) is such that the band gap (7) of the photonic band gap structure (10) is essentially located immediately above or immediately below a specific frequency of the light emitted by the light source (8).

14. Device according to one of the claims 1 to 13, characterised in that in the photonic band gap structure (10) the areas with a reduced or an increased refractive index (15) are realised by pores in a material.

15. Device according to one of the claims 1 to 14, characterised in that the pores (15) enclose the area of the photonic band gap structure (10) with the lower refractive index and the geometry of the photonic band gap structure (10) is such that the band gap (7) is immediately below the frequency of a specific light frequency which is emitted by the light source (8).

16. Device according to one of the claims 1 to 15, characterised in that the areas with the increased (59) and reduced (58) refractive index are in the form of layers.

17. Device according to claim 16, characterised in that the layers (58, 59) along a specific direction in the plane of the layers show a periodic variation in their layer thickness.

18. Device according to one of the claims 1 to 15, characterised in that the areas with a reduced or an increased refractive index (15) are in the form of pillars.

19. Device according to claim 18, characterised in that the pillars (15) have a circular (16), triangular (17), square (18), quadratic (18), rectangular (19), lozenge-shaped (20), polygonal (21) or irregularly shaped (22) or hexagonal (23) cross-section.

20. Device according to claim 18 or 19, characterised in that the front ends of the pillars (15) form an overall periodic pattern.

21. Device according to one of the claims 18 to 20, characterised in that the front surfaces of the pillars (15) in an overall periodic pattern are provided with a hexagonal (25), rhomboid (26), lozenge-shaped (27), square (28) or rectangular (29) unit cell.

22. Device according to one of the claims 18 to 21, characterised in that the pillars (15) show, along their longest extension, a periodicity of the cross-sectional area perpendicular to the longest direction of extension.

23. Device according to one of the claims 1 to 22, characterised in that at least a part of the photonic band gap structure (10) contains open free spaces (15), at least a part of which contains the fluid to be analysed.

24. Device according to claim 23, characterised in that at least a part of the free spaces (15) are open on at least one side of the photonic band gap structure (10).

25. Device according to one of the claims 23 or 24, characterised in that the free spaces (15) are open on at least two sides of the photonic band gap structure (10).

26. Device according to one of the claims 1 to 25, characterised in that the photonic band gap structure (10) shows a graduated refractive index profile at least on one side (35, 36) of the photonic band gap structure (10).

27. Device according to claim 26, characterised in that the graduated refractive index profile is realised by a change in the periodicity length.

28. Device according to one of the claims 26 or 27, characterised in that the graduated refractive index profile is realised by variation in the geometric dimensions of the areas with increased and reduced refractive index.

29. Device according to one of the claims 1 to 28, characterised in that the photonic band gap structure (10) includes a reference area (10′) containing a reference fluid (42) the characteristics and composition of which can be used as a reference for the measurement of the fluid (13, 14) to be analysed.

30. Device according to claim 29, characterised in that the reference area (10′) of the photonic band gap structure (10) is separated at least on one side from the remaining photonic band gap structure (10).

31. Device according to one of the claims 29 or 30, characterised in that the reference fluid in the reference area of the photonic band gap structure is enclosed hermetically by a hermetic closure (41).

32. Device according to one of the claims 1 to 31, characterised in that the photonic band gap structure (10) takes the form of a prism.

33. Device according to one of the claims 1 to 32, characterised in that the photonic band gap structure (10) is made in such a way that the light is split chromatically.

34. Device according to one of the claims 1 to 33, characterised in that the photonic band gap structure (10) has a refractive index profile (30, 31) resulting in a chromatic splitting of the light.

35. Device according to one of the claims 1 to 34, characterised in that within the device for example within the photonic band gap structure (10) a catalyst (38) is provided which has a catalytic effect at least on one component of the fluid (13, 14) to be analysed.

36. Device according to claim 35, characterised in that the catalyst (38) is provided wholly or at least partly on the insides of the free spaces (15) enclosing the fluid (13, 14) to be analysed.

37. Device according to one of the claims 35 or 36, characterised in that a heater (63) is provided for the selective heating of the catalyst (38).

38. Device according to one of the claims 1 to 37, characterised in that the photonic band gap structure (10) essentially contains a material that is essentially transparent at least for one of the wavelengths of the light that is emitted from the light source (8).

39. Device according to one of the claims 1 to 38, characterised in that the photonic band gap structure (10) essentially contains silicon which is preferably monocrystalline.

40. Device according to one of the claims 1 to 39, characterised in that a modulation device (43) is provided for the modulation over time of the intensity of the light emitted by the light source (8).

41. Device according to one of the claims 1 to 40, characterised in that a power modulation device (44) is provided for the modulation over time of the power with which the light source (8) is supplied.

42. Device according to one of the claims 1 to 41, characterised in that a fluid pressure modulation device (45) is provided for the modulation over time of the pressure of the fluid to be analysed.

43. Device according to one of the claims 1 to 42, characterised in that a temperature modulation device (46) is provided for the modulation over time of the temperature of the photonic band gap structure (10).

44. Device according to one of the claims 1 to 43, characterised in that a light detector (11) is provided as the detector for the light that has interacted with the fluid to be analysed.

45. Device according to one of the claims 1 to 44, characterised in that a discrete detector (11) is provided as the detector.

46. Device according to one of the claims 1 to 44, characterised in that a multiple light detector (37) is provided as the detector for detection of the light at several points in the device.

47. Device according to one of the claims 1 to 46, characterised in that a thermoelectric element (52) is provided as the detector.

48. Device according to claim 47, characterised in that the thermoelectric element (52) is provided in the form of layers.

49. Device according to one of the claims 47 or 48, characterised in that the thermoelectric element (52) contains antimony (54) and/or bismuth (53).

50. Device according to one of the claims 1 to 49, characterised in that the intensity of the light emitted by the light source (8) is modulated with a frequency which essentially corresponds to the acoustic frequency of an acoustic resonator mode of the photonic band gap structure (10).

51. Device according to claim 50, characterised in that a microphone (51) is provided for detection of the acoustic oscillations in the photonic band gap structure (10).

52. Device according to claim 51, characterised in that the microphone (51) contains a piezoelectric element.

53. Device according to one of the claims 50 to 52, characterised in that a marking (47) is applied to the photonic band gap structure (10) and this marking (47) moves with the frequency at which the photonic band gap structure (10) stimulated by the light oscillates at its natural frequency.

54. Device according to claim 53, characterised in that a marking light detector (49) is provided for the optical detection of the movement (50) of the marking (47).

55. Device according to one of the claims 40 to 54, characterised in that a filter device (64) is provided for the filtering of the output signal from the detector (11, 51, 49).

56. Device according to claim 55, characterised in that the filter (64) is provided to allow passage essentially of the signal component at the frequency corresponding to the frequency of the modulation of the light intensity, the fluid pressure of the fluid to be analysed or the temperature of the photonic band gap structure (10).

57. Device according to one of the claims 14 to 56, characterised in that the light is provided essentially for propagation at an angle to the axis of the pores in the photonic band gap structure (10).

58. Device according to one of the claims 14 to 56, characterised in that the light is provided essentially for propagation parallel to the axis of the pores in the photonic band gap structure (10).

59. Device according to one of the claims 1 to 58, characterised in that a hose-type guide device (12) is provided to feed the fluid to be analysed in the direction of the photonic band gap structure (10).

60. Device according to one of the claims 1 to 59, characterised in that a flood device (12) is provided for flooding the photonic band gap structure (10) with the fluid to be analysed.

61. Device according to one of the claims 1 to 60, characterised in that the photonic band gap structure is integrated into a micromechanical flow cell.

62. Method for the analysis of the qualitative and/or quantitative composition of fluids using a light source (8) and a detection device (11, 11′, 37, 51 , 47, 48, 49) for the detection of the interaction of the light emitted by the light source (8) with the fluid, characterised in that at least a part of the light from the light source (8) due to the refractive index periodicity of a photonic band gap structure (10) propagates at a group velocity that is reduced in comparison with a vacuum and that at least a part of the light which due to the refractive index periodicity of the photonic band gap structure (10) propagates at a reduced group velocity interacts with a fluid (13) to be analysed.

63. Method according to claim 62, characterised in that the photonic band gap structure (10) is charged with the fluid (13) to be analysed.

64. Method according to claim 62 or 63, characterised in that free spaces (15) in the photonic band gap structure (10) are filled with the fluid to be analysed from one side (61) of the photonic band gap structure (10).

65. Method according to one of the claims 62 to 64, characterised in that the fluid to be analysed (13, 14) is passed through the photonic band gap structure (10).

66. Method according to one of the claims 62 to 65, characterised in that the intensity of the light emitted by the light source (8) is modulated over time.

67. Method according to one of the claims 62 to 66, characterised in that the temperature of the photonic band gap structure (10) is modulated.

68. Method according to one of the claims 62 to 68, characterised in that the power With which the light source (8) is supplied is modulated over time.

69. Method according to one of the claims 62 to 68, characterised in that the pressure of the fluid (13) to be analysed is modulated over time.

70. Method according to one of the claims 62 to 69, characterised in that a chemical reaction in which at least one component of the fluid to be analysed participates is catalysed within the photonic band gap structure (10).

71. Method according to claim 70, characterised in that the starting product of the chemical reaction that is catalysed is analysed qualitatively and/or quantitatively.

72. Method according to one of the claims 70 or 71, characterised in that the end product of the chemical reaction that is catalysed is analysed qualitatively and/or quantitatively.

73. Method according to one of the claims 62 to 72, characterised in that a catalyst (38) is heated.

74. Method according to one of the claims 62 to 73, characterised in that a reference analysis of a known reference fluid (42) is carried out.

75. Method according to one of the claims 72 to 74, characterised in that the starting signal from the detector (11, 11′, 49, 51) is filtered and essentially only those signal components that correspond to a specific modulation frequency are not filtered out.

76. Method according to one of the claims 62 to 75, characterised in that the light that falls on the photonic band gap structure (10) is split dispersively.

77. Method according to claim 76, characterised in that the light is detected spectrally separated.

78. Method according to claim 62 to 77, characterised in that in the photonic band gap structure (10) essentially light propagates that corresponds to an absorption line or absorption band of the fluid component (13) which is being analysed preferably qualitatively and/or quantitatively.
